(19) United States
(12) Patent Application Publication
(10) Pub. No.: US 2025/0142139 A1
(43) Pub. Date: May 1, 2025

(54) SCENE BASED AUDIO MIXING FOR GENERATING AUDIO DESCRIPTION CONTENT

(71) Applicant: Amazon Technologies, Inc.

(72) Inventors: Akash Amol, Patna (IN); Ankit Prem Manocha, Lynnwood, WA (US); Mayank Sharma, Bhopal (IN); Ashutosh Singhal, Bangalore (IN); Jayashree Rajagopalan, Bangalore (IN); Ayotomiwa Ajewole, Austin, TX (US)

(21) Appl. No.: 18/536,053

(22) Filed: Dec. 11, 2023

(30) Foreign Application Priority Data
Oct. 31, 2023 (IN) 202311074336

(51) Int. Cl. H04N 21/233; H04N 21/81

(52) U.S. Cl. CPC H04N 21/2335; H04N 21/8106

(57) ABSTRACT

The present disclosure generally relates to systems and methods for generating an AD content. In some implementation examples, an AD content system obtains and input audio and an AD narration, and normalizes a loudness of a section of the AD narration using a loudness of the input audio during a scene that the section corresponds to for generating a normalized section. Based on a loudness of the normalized section, the AD content system compresses a first audio channel of the input audio during the scene to generate a first compressed audio channel, and mix the normalized section to the first compressed audio channel during the scene to generate a first sound channel of the AD content.

### CROSS-REFERENCE TO RELATED APPLICATION(S)

This application claims priority to Indian Provisional Patent Application No. 202311074336 filed on Oct. 31, 2023 entitled “SCENE BASED AUDIO MIXING FOR GENERATING AUDIO DESCRIPTION CONTENT,” the disclosure of which is hereby incorporated by reference in its entirety. Furthermore, any and all priority claims identified in the Application Data Sheet, or any correction thereto, are hereby incorporated by reference under 37 C.F.R. § 1.57.

### BACKGROUND

An audio description (AD) is a form of narration used to provide information surrounding key visual elements in a multimedia work (e.g., movies, TV shows, or other multimedia content). It is primarily designed to make multimedia works accessible to individuals who are blind or visually impaired (BVI). This narration typically occurs during pauses in dialogue and/or important audio cues to avoid interfering with original audio. Audio descriptions help ensure that people with visual impairment can fully enjoy and comprehend any multimedia content with a visual component by providing essential visual context through spoken narration.

### BRIEF DESCRIPTION OF THE DRAWINGS

FIG. 1 depicts an example computing environment in which embodiments of the present disclosure can be implemented by an AD content system to generate AD content according to some embodiments.

FIG. 2 depicts an example block diagram of the AD content system of FIG. 1 for automatically generating AD content based on an input audio and an AD narration according to some embodiments.

FIGS. 3 and 4 depict example interactions for automatically generating an AD content on the AD content system in FIG. 2 according to some embodiments.

FIG. 5 depicts an example block diagram of an AD normalizer in FIG. 2 according to some embodiments.

FIG. 6 depicts an example block diagram of an input audio compression module in FIG. 2 according to some embodiments.

FIG. 7 illustrates an example routine for mixing an AD narration and an input audio to generate an AD content according to some embodiments.

FIG. 8 depicts a general architecture of an AD content system that is capable of automatically generating an AD content according to some embodiments.

### DETAILED DESCRIPTION

Generally described, aspects of the present disclosure relate to systems and methods that utilize various signal processing techniques or algorithms to automatically generate audio description (AD) content for multimedia content, such as video content items with corresponding audio. More specifically, some embodiments of the present disclosure relate to an AD content system (or simply a “system”) that can advantageously generate an AD narration based on an AD script describing visual elements of a multimedia content item, and mix the AD narration with an original version (OV) of audio in the multimedia content item to generate AD content. Beneficially, the system may use scene-based audio processing algorithms such that both the OV audio and the AD narration in the AD content are audible to result in comfortable and non-disruptive hearing experiences.

An AD, also referred to as an “AD audio track,” “AD narration” or “descriptive audio,” is an additional audio track that provides a narration of visual elements (e.g., scenes, characteristics, or events) in a movie, TV show, or other multimedia content with a visual component. When an audio description is enabled, a narrator describes key visual details, actions and scene changes where there is no dialogue, thereby allowing viewers who are blind or visually impaired (BVI) to better understand what is happening on the screen. An AD narration typically occurs during pauses in dialogue and/or important audio cues to avoid interfering with an OV audio.

Current processes of creating AD content usually include performing various unintegrated, fragmented, or manual steps. For example, a scriptwriter first creates an AD script by watching a multimedia content item. Second, AD narrator(s) narrate the AD script in their own voice. Third, mixing expert(s) mix an AD narration with an OV audio based on an audio channel layout (e.g., 5.1, 7.1, or the like) of the OV audio. However, some or all of the above steps may be time-consuming (e.g., taking an order of magnitude longer to complete than the runtime of the OV content), costly, and labor intensive, making the processes unscalable and unsuitable for creating large size or number of AD content.

Additionally, creating AD content that leads to satisfying user experiences can be technically challenging because of varying sound loudness levels/ranges among various scenes in an OV audio. For example, action scenes in the OV audio may have relatively high loudness levels, while romantic scenes in the same OV audio may have relatively low loudness levels. Mixing an AD narration into action scenes in the OV audio without reducing loudness levels of the OV audio may result in disruptive user experience because the AD narration may not be audible. In contrast, reduction in loudness levels of the OV audio during romantic scenes may be unnecessary or minimal when mixing the AD narration into the romantic scenes. In addition, setting the loudness of AD narration such that it is able to be heard during action scenes may result in AD narration that is too loud for romantic scenes, while setting the loudness of AD narration such that it does not overpower romantic scenes may result in AD narration that is not loud enough for action scenes. As such, mixing the AD narration with the OV audio without accounting for varying loudness levels among scenes in the OV audio may lead to inferior listening experiences.

To address at least a portion of the technical problems described above, some embodiments of the present disclosure utilize various machine learning and audio processing techniques to implement scene-based audio mixing algorithm(s) to automatically generate AD content efficiently (e.g., within minutes, depending on level of parallelism associated with available hardware resources). In addition, the user experience may be enhanced by adjusting loudness levels of an AD narration and/or an OV audio by taking into consideration both loudness levels of scenes in the OV audio and loudness levels of the AD narration during corresponding time periods of the scenes.

To efficiently generate AD content through automation without causing inferior user experiences, some disclosed techniques utilize scene-by-scene compression to compress the OV audio based on the AD narration that is to be mixed with the OV audio. More specifically, for scene(s) during which a loudness of the AD narration surpasses a loudness of the OV audio, the system may not compress the OV audio, or may compress the OV audio to a relatively small degree. But for scene(s) during which the loudness of the AD narration is surpassed by the loudness of the OV audio, the system may compress the OV audio such that the AD narration may be audible in the AD content. In various implementations, the system may compress (e.g., using side chain compression) the OV audio to various degrees using various compression instructions and/or parameters based on differences between the loudness of the AD narration and the loudness of the OV audio among various scenes. Advantageously, compressing the OV audio by taking differences between the loudness of the AD narration and the loudness of the OV audio among various scenes into considerations may help achieve non-disruptive user experiences.

Additionally and/or optionally, prior to compressing the OV audio based on the AD narration, the system may normalize a loudness of the AD narration using a loudness of the OV audio while maintaining the loudness of the AD narration within a predetermined range. The system may then compress (e.g., using side chain compression) the OV audio based at least on a normalized loudness of the AD narration. Advantageously, normalizing the loudness of the AD narration may help improve the audio contrast with the OV audio. Moreover, maintaining the loudness of the AD narration within a predetermined range can help prevent the AD narration from being obtrusive (e.g., too loud) or lost (e.g., too quiet) in an AD content.

To reduce time for generating the AD content, the system may optionally employ multiple processor cores to compress an OV audio during various scenes based on a loudness of an AD narration. In some embodiments, the OV audio during a first subset of scenes may be compressed by a first processor core based on a normalized loudness of the AD narration during the first subset of scenes, and the OV audio during a second subset of scenes may be compressed by a second processor core based on a normalized loudness of the AD narration during the second subset of scenes. Advantageously, employing multiple processors to concurrently or simultaneously compress OV audio during various scenes may allow the system to generate an AD content in less amount of time.

Additionally and/or optionally, the system may generate compression instructions and/or parameters to be utilized by the processor cores for compressing an OV audio based on differences between a loudness of an AD narration and a loudness of the OV audio during various scenes. In some embodiments, the system may classify a difference between the loudness of the AD narration and the loudness of the OV audio during a first scene to a first range of a plurality of ranges, and classify a difference between the loudness of the AD narration and the loudness of the OV audio during a second scene to a second range of the plurality of ranges. Based on the first range, the system may generate a first set of parameters for compressing the OV audio using the loudness of the AD narration during the first scene. Based on the second range, the system may generate a second set of parameters for compressing the OV audio using the loudness of the AD narration during the second scene. The first set of parameters may be utilized by a first processor core to compress the OV audio during the first scene based on the loudness of the AD narration during the first scene. The second set of parameters may be utilized by a second processor core to compress the OV audio during the second scene based on the loudness of the AD narration during the second scene. Advantageously, classifying the differences between the loudness of the AD narration and the loudness of the OV audio during various scenes enables the system to adequately customize compression instructions and/or parameters such that the OV audio may be compressed to a greater degree during scenes where the loudness of the OV audio surpasses the loudness of the AD narration by greater degrees.

Embodiments disclosed herein improve the ability of computing systems, such as computer system for efficiently generating AD content through mixing AD audio with OV audio, in particular when generating a large size or a large quantity of AD content items. Moreover, the presently disclosed embodiments address technical problems inherent within computing systems; specifically, the limited ability of a computing system to generate quality AD content automatically without inaudible or obtrusive AD narration when loudness of OV audio varies across scenes.

These technical problems are addressed by the various technical solutions described herein, including, but not limited to, utilizing scene-by-scene compression to compress the OV audio based on the AD narration that is to be mixed with the OV audio, compressing the OV audio to various degrees using various compression instructions based on differences between the loudness of the AD narration and the loudness of the OV audio at various scenes, and normalizing a loudness of the AD narration using a loudness of the OV audio to maintain the loudness of the AD narration to a predetermined range. Thus, the present disclosure represents an improvement in AD content generation systems and computing systems in general.

As used herein, the term “OV audio” (also referred to as “input audio” or “OV track”) can refer to original audio track(s) to which an AD narration is to be mixed in. An OV audio can include one or more audio tracks of a multimedia work (e.g., movies, TV shows, or other multimedia content) that has no AD narration. As used herein, the term “side chain compression” can refer to an audio compression algorithm or an audio compressor that performs audio compression (e.g., reduce a loudness of an audio) on a primary audio input (e.g., OV audio) based on a secondary audio input (e.g., AD narration). Side chain compression may compress the primary audio input to various degrees based on the parameters and/or instructions used by the side chain compression. As used herein, the term “dynamic range” can refer to a difference between the loudest sound and the quietest sound of an audio. For example, the dynamic range of an audio can be 10 dB, 50 dB, 75 dB, 100 dB, 150 dB, or the like, or any range of values therebetween. As used herein, the term “loudness” can refer to a loudness or a volume level of an audio or an audio channel. The term loudness, loudness level, and volume can be used interchangeably to indicate how loud or quiet an audio or an audio channel is.

Various aspects of the disclosure will now be described with regard to certain examples and embodiments, which are intended to illustrate but not limit the disclosure. Although aspects of some embodiments described in the disclosure will focus, for the purpose of illustration, on particular examples of audio channel layouts and audio processing algorithms, the examples are illustrative only and are not intended to be limiting. In some embodiments, the techniques described herein may be applied to or incorporated with additional or alternative audio channel layouts, audio processing algorithms, and the like.

### Example System and Related Computing Environment

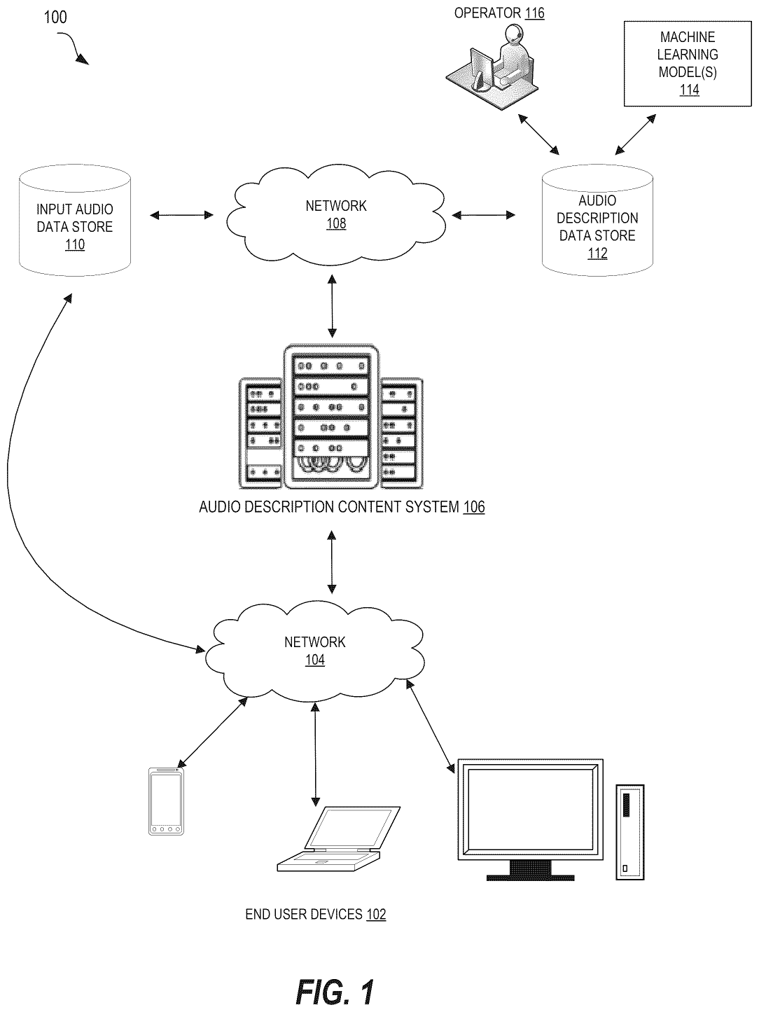

FIG. 1 depicts an example computing environment 100 in which embodiments of the present disclosure can be implemented by an AD content system 106 to automatically generate AD content for multimedia content. The computing environment 100 may include the AD content system 106, a network 108, any number of input audio data stores 110, a network 104, any number of AD data stores 112, any number of operator(s) 116, any number of machine learning model(s) 114, and end user devices 102. The AD content system 106 can be accessed by the end user devices 102 through the network 104. In some embodiments, the AD content system 106 can be implemented by one or more computing devices for processing multimedia content, such as generating an AD narration based on an AD script, and/or mixing the AD narration with an OV audio in a multimedia work to generate an AD content.

The AD content system 106 may be a logical association of one or more computing devices for obtaining, processing, storing and/or distributing AD content. The AD content system 106 (or individual components thereof not shown in FIG. 1) may be implemented on one or more physical server computing devices. In some embodiments, the AD content system 106 (or individual components thereof) may be implemented on one or more host devices, such as blade servers, midrange computing devices, mainframe computers, desktop computers, or any other computing device configured to provide computing services and resources.

In some embodiments, the features and services provided by the AD content system 106 may be implemented as web services consumable via one or more communication networks (e.g., the network 108 and the network 104). In further embodiments, the AD content system 106 (or individual components thereof) is provided by one or more virtual machines implemented in a hosted computing environment. The hosted computing environment may include one or more rapidly provisioned and released computing resources, such as computing devices, networking devices, and/or storage devices.

In some embodiments, the AD content system 106 may be a part of a cloud provider network (e.g., a “cloud”), which may correspond to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to provide various services, such as automatically generating AD content for multimedia content and/or performing audio processing techniques as disclosed in the present disclosure. The computing services provided by the cloud that may include the AD content system 106 can thus be considered as both the applications delivered as services over a publicly accessible network (e.g., the Internet, a cellular communication network) and the hardware and software in cloud provider data centers that provide those services.

Additionally, end user devices 102 may communicate with the AD content system 106 via various interfaces such as application programming interfaces (API) as a part of cloud-based services. In some embodiment, the AD content system 106 may interact with the end user devices 102 through one or more user interfaces, command-line interfaces (CLI), application programing interfaces (API), and/or other programmatic interfaces for requesting actions or services, such as retrieving AD content that may be automatically generated by the AD content system 106. For example, the AD content system 106 may transmit through the network 104 AD content generated by some of the audio compression and mixing techniques described in the present disclosure to the end user devices 102.

Various example end user devices 102 are shown in FIG. 1, including a desktop computer, laptop, and a mobile phone, each provided by way of illustration. In general, the end user devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like.

In some embodiments, the network 104 and/or the network 108 includes any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In some embodiments, the AD content system 106 may access data stored in the input audio data store 110 via the network 108. The input audio data store 110 may store OV audio in a multimedia work that will be utilized by the AD content system 106 to automatically generate AD content for multimedia content. As illustrated in FIG. 1, end user devices 102 may also access the input audio data store 110 via various interfaces such as application programming interfaces (API) as a part of cloud-based services.

In some embodiments, the input audio data store 110 may be any computer-readable storage medium and/or device (or collection of data storage mediums and/or devices). Examples of the input audio data store 110 include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. For example, the input audio data store 110 and the AD content system 106 may be parts of a hosted storage environment that includes a collection of physical data storage devices that may be remotely accessible and may be rapidly provisioned as needed (commonly referred to as “cloud” storage).

Additionally, the AD content system 106 may access data stored in the AD data store 112 via the network 108. The AD data store 112 may store AD scripts that may be generated by the operator 116 through watching multimedia works. Alternatively and/or optionally, AD scripts may be generated by one or more machine learning model(s) 114 through analyzing the multimedia works. The AD data store 112 may be any computer-readable storage medium and/or device (or collection of data storage mediums and/or devices). Examples of the AD data store 112 include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. For example, the AD data store 112 and the AD content system 106 may be parts of a hosted storage environment that includes a collection of physical data storage devices that may be remotely accessible and may be rapidly provisioned as needed (commonly referred to as “cloud” storage).

In some embodiments, the AD content system 106 may generate an AD narration based on an AD script stored in the AD data store 112. The AD content system 106 may then mix the AD narration with an OV audio in a multimedia work that is stored in the input audio data store 110 to generate an AD content. For example, the AD content system 106 may utilize scene-by-scene compression to compress the OV audio based on the AD narration that is to be mixed with the OV audio. More specifically, for scene(s) during which a loudness of the AD narration surpasses a loudness of the OV audio, the AD content system 106 may not compress the OV audio, or may compress the OV audio to a relatively small degree. But for scene(s) during which the loudness of the AD narration is surpassed by the loudness of the OV audio, the AD content system 106 may compress the OV audio such that the AD narration may be audible in an AD content. In various implementations, the AD content system 106 may compress (e.g., using side chain compression) the OV audio to various degrees using various compression parameters or instructions based on differences between the loudness of the AD narration and the loudness of the OV audio among various scenes. Advantageously, compressing the OV audio by taking differences between the loudness of the AD narration and the loudness of the OV audio among various scenes into considerations may help achieve non-disruptive user experiences.

### Example System and Related Modules

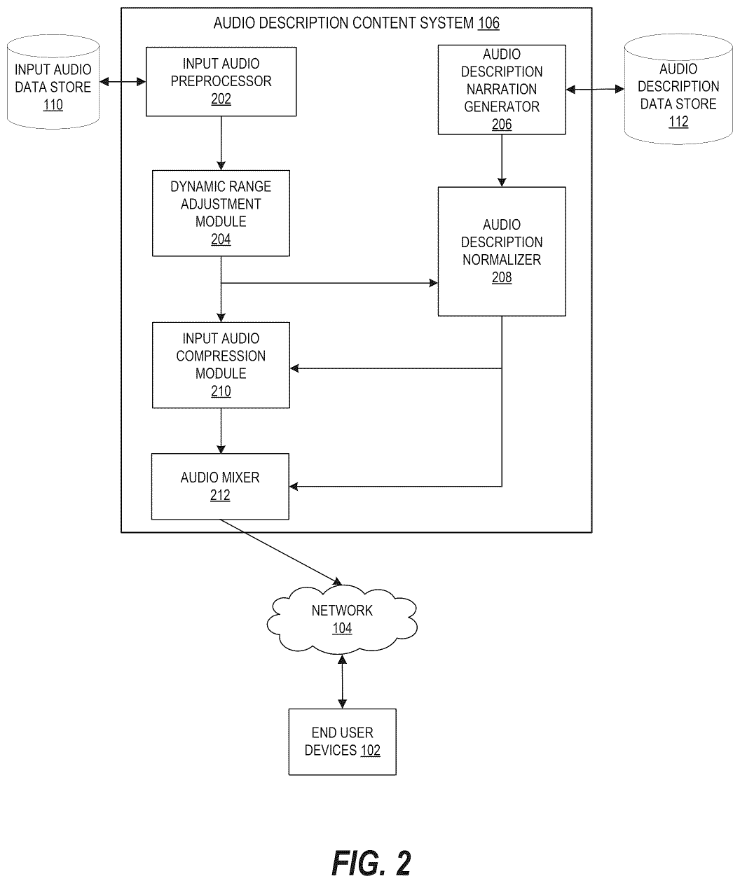

FIG. 2 depicts an example block diagram of the AD content system 106 of FIG. 1, where the AD content system 106 can be utilized to generate an AD content based on data stored in the input audio data store 110 and the AD data store 112, and store or transmit the AD content to other computing devices, such as the end user devices 102. The AD content system 106 includes an input audio preprocessor 202, a dynamic range adjustment module 204, an AD narration generator 206, an AD normalizer 208, an input audio compression module 210, and an audio mixer 212. In various implementations, the input audio preprocessor 202, the dynamic range adjustment module 204, the AD narration generator 206, the AD normalizer 208, the input audio compression module 210, and the audio mixer 212 can be implemented as software components that program hardware (e.g., processors) to perform respective functions.

The input audio preprocessor 202 may obtain an input audio (e.g., an OV audio that may be an original audio track to which an AD narration is to be mixed with) from the input audio data store 110. In some embodiments, the input audio preprocessor 202 may determine one or more audio properties of the input audio. For example, the input audio preprocessor 202 may determine a number of audio streams, a number of audio channels, runtime, an audio container, an audio codec, an audio sample rate, or the like of the input audio. Based on determined audio properties, the input audio preprocessor 202 may preprocess the input audio. For example, the input audio preprocessor 202 may determine that the input audio has a 5.1 audio channel layout (e.g., an audio stream with six channels: Front-Left (FL), Front-Right (FR), Front-Center (FC), Low-Frequency-Effects (LFE), Back-Left (BL), and Back-Right (BR)), and split the input audio into six audio channels (e.g., FL, FR, FC, LFE, BL, and BR) based on the determination.

Based on the pre-processing that may be performed by the input audio preprocessor 202, the dynamic range adjustment module 204 may adjust a dynamic range of the input audio. For example, assuming the input audio preprocessor 202 splits the input audio into six audio channels (e.g., FL, FR, FC, LFE, BL, and BR), the dynamic range adjustment module 204 may adjust dynamic ranges of some or all of the six audio channels, respectively. For example, the dynamic range adjustment module 204 may adjust a dynamic range of the FL channel, the FR channel, the FC channel, the LFE channel, the BL channel, and/or the BR channel to one or more desired values (e.g., 10 dB, 50 dB, 75 dB, 100 dB, 150 dB, or the like, or any range of values therebetween). In some embodiments, the dynamic range adjustment module 204 may adjust a dynamic range of an audio channel such that the loudest sound of the audio channel may be limited to an upper level (e.g., −7 dB, or any other levels), while the quieter sounds of the audio channel are maintained at their present levels. In further embodiments, the dynamic range adjustment module 204 may reduce (e.g., compress) dynamic range of one or more audio channels of the input audio. For example, the dynamic range adjustment module 204 may make quiet sounds of the FR channel (or any other channels) louder and make loud sounds of the FR channel quieter. Additionally and/or optionally, the dynamic range adjustment module 204 may increase (e.g., expand) the dynamic range of one or more audio channels of the input audio. For example, the dynamic range adjustment module 204 may make quiet sounds of the BL channel (or any other channels) quieter and make the loud sounds of the BL channel louder. In various implementations, the dynamic range adjustment module 204 may be implemented by one or more compand (e.g., compression and expansion) filters that may be programmable and/or reconfigurable based on compand instructions.

In some embodiments, the AD narration generator 206 may generate an AD narration based on an AD script that may be stored in the AD data store 112, where the AD narration may include multiple AD sections. As noted above, the AD script may be generated by operator 116 and/or machine learning model(s) 114 through watching and/or processing a multimedia work. In some embodiments, the AD script may include narration texts that are tagged with Speech Synthesis Markup Language (SSML) tags. The AD script may indicate a start time, an end time, and narration text for each AD section of the AD narration that is to be generated. Based on information included in the AD script, the AD narration generator 206 may generate the AD narration using various voice synthesizers. For example, the AD narration generator 206 may generate the AD narration using computer synthesized speech, such as a neural text to speech (NTTS) synthesizer, large language model text to speech (LTTS) synthesizer, or any other types of computer speech synthesizers. In various implementations, a computer speech synthesizer may be configured in a multi-threaded fashion such that AD sections of the AD narration may be generated in parallel to conserve processing time. Additionally and/or optionally, the AD narration generator 206 may further convert the AD narration synthesized by the NTTS synthesizer to one or more desired formats. For example, the AD narration synthesized by the NTTS synthesizer may be in the “.pcm” file format, and the AD narration generator 206 may convert the AD narration from the “pcm” format to the “.wav” format, or any other formats desired by the AD content system 106.

In some embodiments, an AD narration generated by the AD narration generator 206 may include a plurality of AD sections, where each of the plurality of AD sections may correspond to a scene in the input audio. The plurality of AD sections may correspond to a subset of scenes of scenes in the input audio. For example, the AD narration may have n AD sections and the input audio may have 2n, 2n+1, or 2n−1 scenes, where the n AD sections may correspond to n scenes in the input audio.

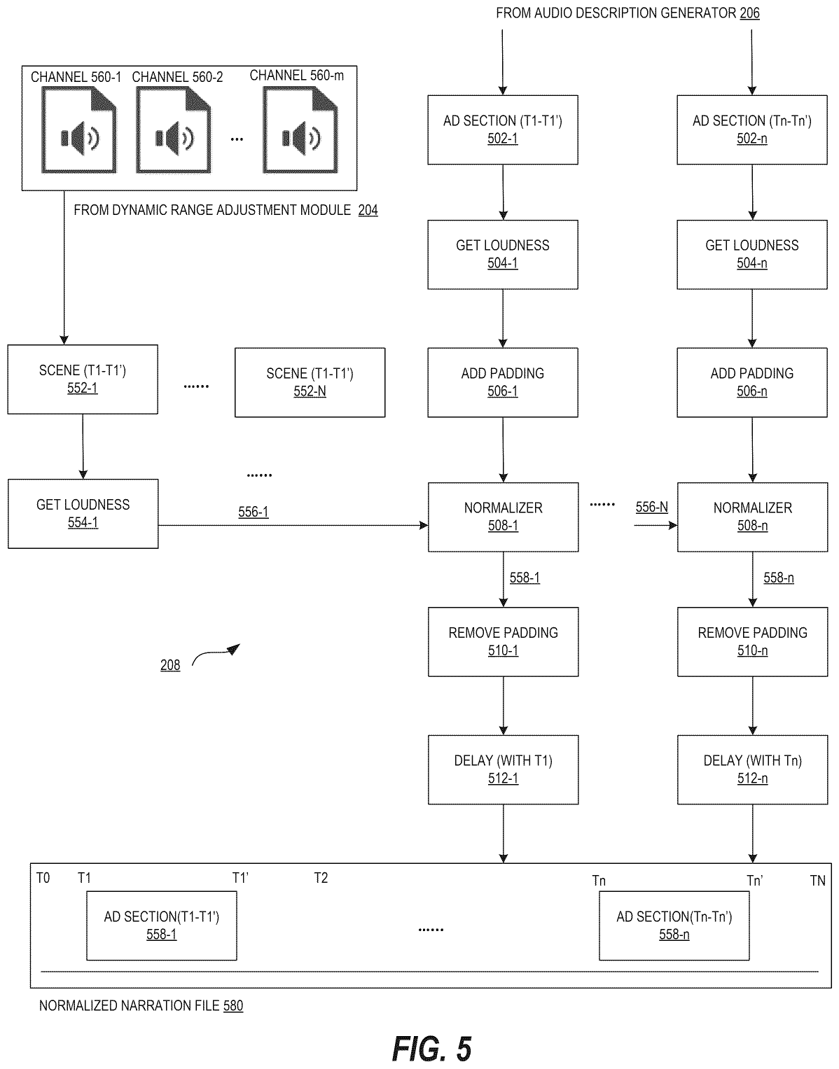

In some embodiments, the AD normalizer 208 may normalize a loudness of some or all of AD sections of an AD narration based on a loudness of the input audio, where the loudness of the input audio may take into account a loudness of some or all audio channels of the input audio. For example, for an AD section, the AD normalizer 208 may normalize a loudness of the AD section using a loudness associated with one or more audio channels of the input audio to generate a normalized AD section. More specifically, through normalization on the AD section, the AD normalizer 208 may raise or lower the loudness of the AD section based on the loudness associated with one or more audio channels of the input audio. Additionally and/or optionally, the AD normalizer 208 may keep a loudness of the normalized AD section to a predetermined range (e.g., the quietest sound in the normalized AD section is above a first decibel value and the loudest sound in the normalized AD section is below a second decibel value that is higher than the first decibel value). Advantageously, keeping the loudness of the normalized AD section to the predetermined range may help prevent the loudness of the normalized AD section from being lowered down to a volume of a whisper that is inaudible or from being raised to a volume of a scream that is obtrusive. Example implementations of the AD normalizer 208 will be described in FIG. 5 with greater detail.

In some embodiments, the AD normalizer 208 may further generate a normalized narration file based on normalized AD sections. As noted above, an AD section may correspond to a scene in the input audio, where the scene has a start time and an end time. The AD normalizer 208 may insert each of the normalized AD sections according to a start time and an end time of each of the normalized AD sections to a silent audio file to generate the normalized narration file. As such, the normalized narration file may include each of the normalized AD sections. In some embodiments, the normalized narration file may have a duration that is the same as a duration of the input audio. For example, both the normalized narration file and the input audio may have ninety minutes in length. In various implementations, the normalized narration file may include n sections that correspond to n AD sections of an AD narration, and n, n−1, or n+1 sections of silent audio.

In some embodiments, the input audio compression module 210 may compress one or more audio channels of the input audio based at least in part on a loudness of normalized AD sections to generate one or more compressed audio channels. For example, based on a loudness of a normalized AD section that corresponds to a scene of the input audio, the input audio compression module 210 may compress (e.g., using side chain compression) an audio channel (e.g., LFE) of the input audio during the scene to generate a portion of a compressed LFE channel. In various implementations, the input audio compression module 210 may compress an audio channel of the input audio during a scene based on a difference between a loudness of a normalized AD section that corresponds to the scene and a loudness associated with the input audio during the scene, where the loudness associated with the input audio during the scene may take into account a loudness of each audio channel (e.g., a loudness of an audio that is mixed with each audio channel) of the input audio during the scene.

In some embodiments, the input audio compression module 210 may determine the difference between the loudness of the normalized AD section that corresponds to the scene and the loudness associated with the input audio during the scene with reference to European Broadcasting Union (EBU) R 128. Specifically, the input audio compression module 210 may measure or obtain the loudness of the normalized AD section that corresponds to the scene and the loudness associated with the input audio during the scene pursuant to EBU R 128, and calculate the difference between the loudness of the normalized AD section that corresponds to the scene and the loudness associated with the input audio during the scene. Based on the difference, the input audio compression module 210 may classify the difference to a range of a plurality of ranges. For example, the difference between the loudness of the normalized AD section that corresponds to the scene and the loudness associated with the input audio during the scene may be classified by the input audio compression module 210 to one of nine, ten, eleven, or any other number of ranges. Based on the classification, the input audio compression module 210 may generate parameters suitable for compressing one or more audio channels of the input audio during the scene. For a scene where a loudness of a normalized AD section is much lower than a loudness associated with the input audio during the scene, the input audio compression module 210 may generate a set of parameters for compressing one or more audio channels of the input audio during the scene. For a scene where a loudness of a normalized AD section is approaching a loudness associated with the input audio during the scene, the input audio compression module 210 may generate a different set of parameters for compressing one or more audio channels of the input audio during the scene minimally. Advantageously, compressing the input audio by taking differences between the loudness of the AD narration and the loudness of the input audio among various scenes into considerations may help achieve non-disruptive user experiences.

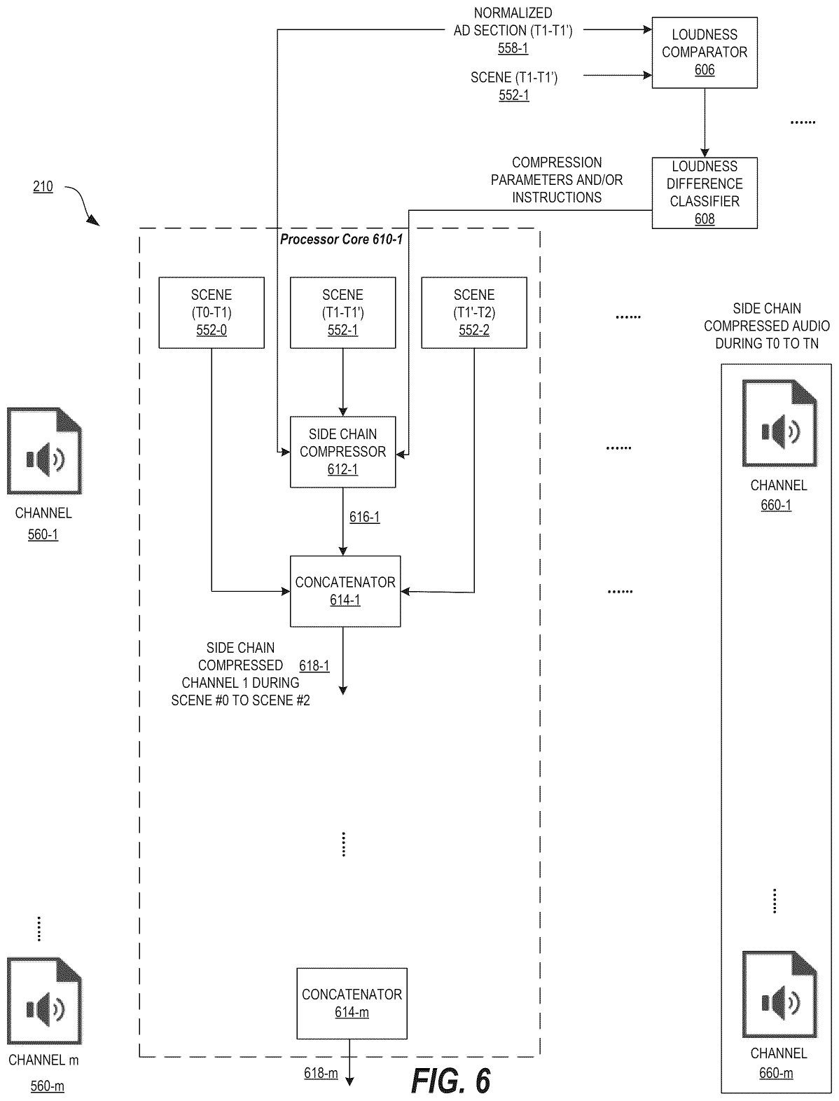

As noted above, the input audio compression module 210 may optionally employ multiple processor cores to compress an input audio during various scenes based on a loudness of an AD narration. In some embodiments, the input audio during a first subset of scenes may be compressed by a first processor core based on a normalized loudness of the AD narration during the first subset of scenes, and the input audio during a second subset of scenes may be compressed by a second processor core based on a normalized loudness of the AD narration during the second subset of scenes. Audio channels of an input audio during the same scene may be compressed by the same processor core. Additionally and/or optionally, an audio channel of the input audio during various scenes may be compressed by the same processor core. Advantageously, employing multiple processors to concurrently compress input audio during various scenes may allow the AD content system 106 to generate an AD content in less amount of time compared with using a single core for an entire content item. Example implementations of the input audio compression module 210 will be described in FIG. 6 with greater detail.

In some embodiments, the audio mixer 212 may mix normalized AD sections to one or more compressed audio channels generated by the input audio compression module 210 during scenes corresponding to the normalized AD sections to generate one or more sound channels of an AD content. For example, the audio mixer 212 may mix a normalized narration file generated by the AD normalizer 208 to a compressed audio channel (e.g., compressed FC channel) to generate a FC channel of the AD content. The audio mixer 212 may generate other sound channels of the AD content using other compressed audio channels (e.g., compressed FL channel, compressed FR channel, compressed LFE channel, compressed BL channel, and compressed BR channel) generated by the input audio compression module 210 without mixing the normalized AD sections to the other compressed audio channels.

In some embodiments, after mixing normalized AD sections to generate a sound channel of an AD content, the audio mixer 212 may optionally boost the sound channel of the AD content without boosting other sound channels of the AD content. Advantageously, boosting the sound channel mixed with AD narration may help achieve non-disruptive user experiences.

### Example System Functionality and Interactions of Related Aspects

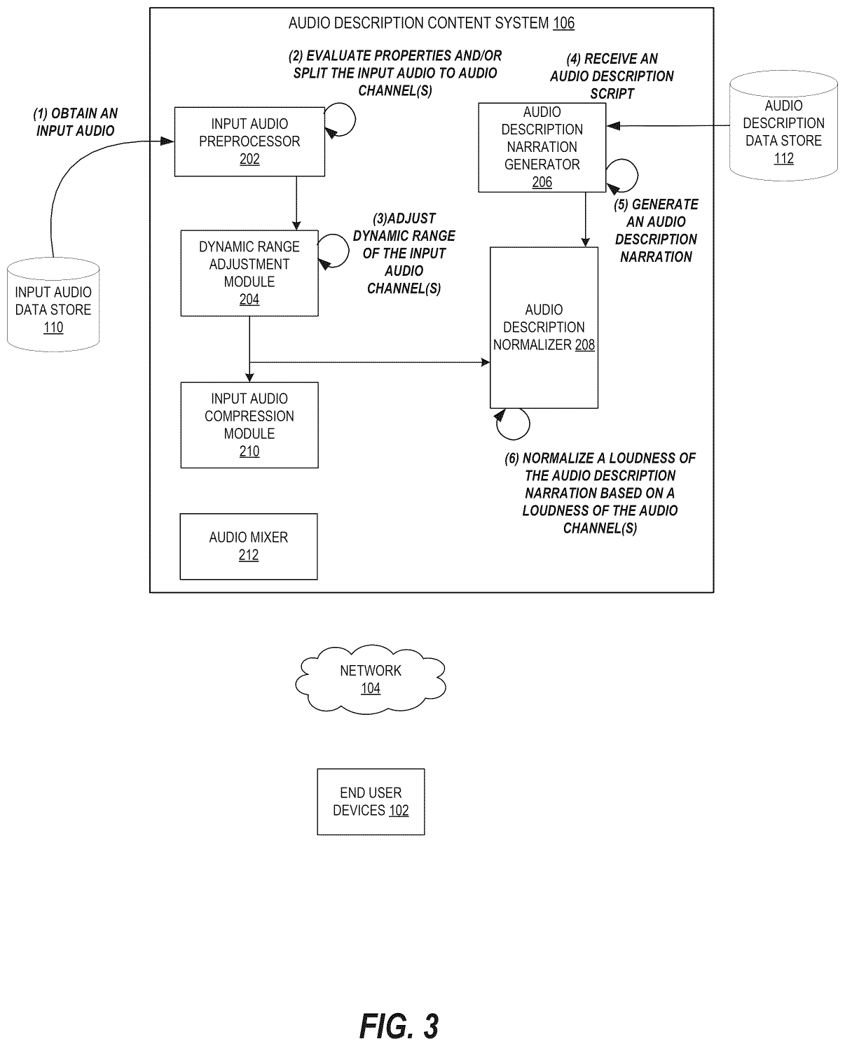

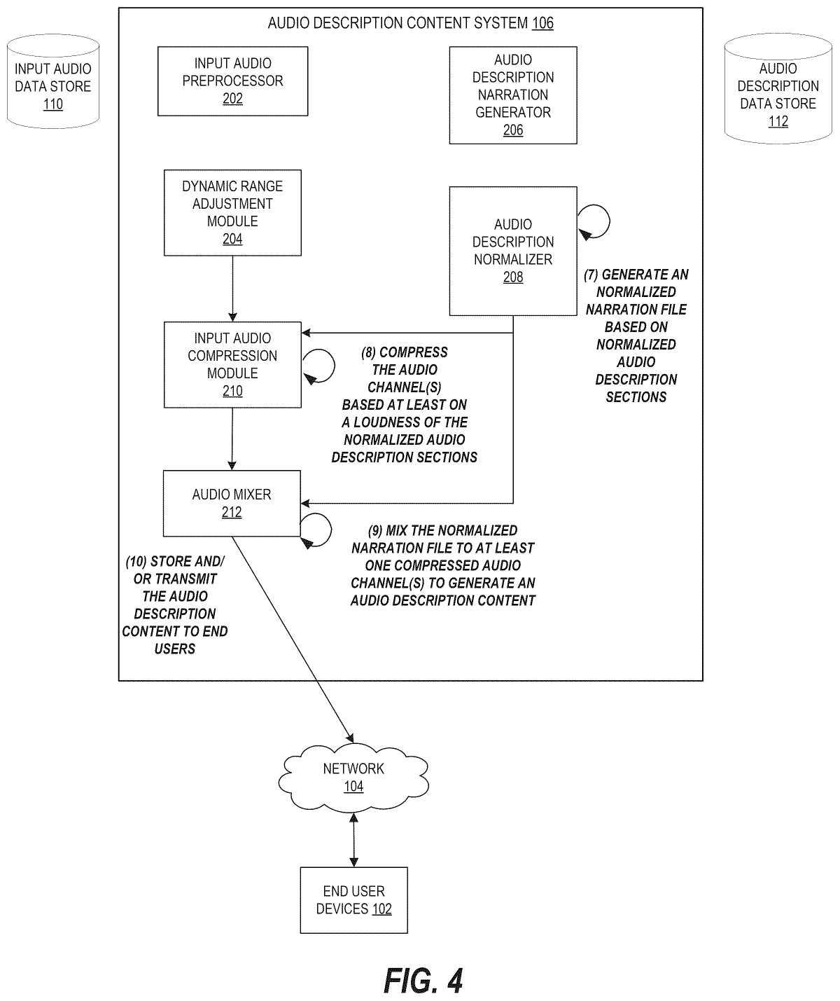

With reference to FIGS. 3 and 4, illustrative interactions will be described depicting how elements (e.g., the AD narration generator 206, the AD normalizer 208, the input audio compression module 210, and the audio mixer 212) of the AD content system 106 of FIG. 2 can automatically generate AD content while achieving quality user experiences by adjusting loudness levels of an AD narration and/or an input audio by taking into consideration both loudness levels of scenes in the input audio and loudness levels of the AD narration during corresponding time periods of the scenes. Although a particular sequence of interactions is illustrated in FIGS. 3 and 4, it should be noted that some of the interactions may be changed in order, performed concurrently, and/or omitted.

The interactions of FIG. 3 begin at (1), where the input audio preprocessor 202 obtains an input audio from the input audio data store 110. The input audio data store 110 may store an input audio in a multimedia work that will be utilized by the AD content system 106 to automatically generate AD content for multimedia content.

At (2), the input audio preprocessor 202 evaluates properties and/or splits the input audio to audio channel(s). In some embodiments, the input audio preprocessor 202 may determine a number of audio streams, a number of audio channels, runtime, an audio container, an audio codec, an audio sample rate, or the like of the input audio. Based on determined audio properties, the input audio preprocessor 202 may optionally split the input audio to one or more audio channels. For example, the input audio preprocessor 202 may determine that the input audio has a 5.1 audio channel layout (e.g., an audio stream with six channels: Front-Left (FL), Front-Right (FR), Front-Center (FC), Low-Frequency-Effects (LFE), Back-Left (BL), and Back-Right (BR)), and split the input audio into six audio channels (e.g., FL, FR, FC, LFE, BL, and BR) based on the determination.

At (3), the dynamic range adjustment module 204 may adjust a dynamic range of the input audio. For example, the dynamic range adjustment module 204 may adjust a dynamic range of the FL channel, the FR channel, the FC channel, the LFE channel, the BL channel, and/or the BR channel in an input audio to one or more desired values (e.g., 10 dB, 50 dB, 75 dB, 100 dB, 150 dB, or the like, or any range of values therebetween). In some embodiments, the dynamic range adjustment module 204 may adjust a dynamic range of an audio channel such that the loudest sound of the audio channel may be limited to an upper level (e.g., −7 dB, or any other levels). In further embodiments, the dynamic range adjustment module 204 may reduce (e.g., compress) dynamic range of one or more audio channels of the input audio. For example, the dynamic range adjustment module 204 may make quiet sounds of the FR channel (or any other channels) louder and make loud sounds of the FR channel quieter. Additionally and/or optionally, the dynamic range adjustment module 204 may increase (e.g., expand) the dynamic range of one or more audio channels of the input audio. For example, the dynamic range adjustment module 204 may make quiet sounds of the BL channel (or any other channels) quieter and make the loud sounds of the BL channel louder.

At (4), the AD narration generator 206 receives an AD script from the AD data store 112. The AD script may be generated by operator 116 and/or machine learning model(s) 114 through watching and/or processing a multimedia work. In some embodiments, the AD script may include narration texts that are tagged with Speech Synthesis Markup Language (SSML) tags. The AD script may indicate a start time, an end time, and narration text for each AD section of the AD narration that is to be generated.

At (5), the AD narration generator 206 may generate an AD narration based on the AD script, using various voice synthesizers. For example, the AD narration generator 206 may generate the AD narration using computer synthesized speech, such as a neural text to speech (NTTS) synthesizer, large language model text to speech (LTTS) synthesizer, or any other types of computer speech synthesizers. In various implementations, a computer speech synthesizer may be configured in a multi-threaded fashion such that AD sections of the AD narration may be generated in parallel to conserve processing time. Additionally and/or optionally, the AD narration generator 206 may further convert the AD narration synthesized by the NTTS synthesizer to one or more desired formats. For example, the AD narration synthesized by the NTTS synthesizer may be in the “.pcm” file format, and the AD narration generator 206 may convert the AD narration from the “pcm” format to the “.wav” format, or any other formats desired by the AD content system 106. The AD narration generated by the AD narration generator 206 may include a plurality of AD sections, where each of the plurality of AD sections may correspond to a scene in the input audio. The plurality of AD sections may correspond to a subset of scenes in the input audio. For example, the AD narration may have n AD sections and the input audio may have 2n, 2n−1, or 2n+1 scenes, where the n AD sections may correspond to n scenes in the input audio.

Accordingly, at (6), the AD normalizer 208 may normalize a loudness of the AD narration based on a loudness of the audio channel(s) of the input audio. The loudness of the audio channel(s) of the input audio may be a loudness of an audio that is mixed with each audio channel(s) of the input audio. In some embodiments, for each AD section of the AD narration, the AD normalizer 208 may normalize a loudness of the AD section using a loudness of an audio that is mixed with each audio channel(s) of the input audio to generate a normalized AD section. More specifically, through normalization on the AD section, the AD normalizer 208 may raise or lower the loudness of the AD section based on the loudness of an audio that is mixed with each audio channel(s) of the input audio. Additionally and/or optionally, the AD normalizer 208 may keep a loudness of the normalized AD section to a predetermined range (e.g., the quietest sound in the normalized AD section is above a first decibel value and the loudest sound in the normalized AD section is below a second decibel value that is higher than the first decibel value).

The interactions of FIG. 3 are continued with reference to FIG. 4, where at (7), the AD normalizer 208 may generate an intermediate file, such as a normalized narration file, based on normalized AD sections. The AD normalizer 208 may insert each of the normalized AD sections according to a start time and an end time of each of the normalized AD sections to a silent audio file to generate the normalized narration file. As such, the normalized narration file may include each of the normalized AD sections. In some embodiments, the normalized narration file may have a duration that is the same as a duration of the input audio. For example, both the normalized narration file and the input audio may have ninety minutes in length. In various implementations, the normalized narration file may include n sections that correspond to n AD sections of an AD narration, and n+1 sections of silent audio.

At (8), the input audio compression module 210 may compress the audio channel(s) of the input audio based at least on a loudness of the normalized AD sections. For example, based on a loudness of a normalized AD section that corresponds to a scene of the input audio, the input audio compression module 210 may compress (e.g., using side chain compression) an audio channel (e.g., LFE) of the input audio during the scene to generate a portion of a compressed LFE channel. In various implementations, the input audio compression module 210 may compress an audio channel of the input audio during a scene based on a difference between a loudness of a normalized AD section that corresponds to the scene and a loudness associated with the input audio during the scene, where the loudness associated with the input audio during the scene may take into account a loudness of each audio channel (e.g., a loudness of an audio that is mixed with each audio channel) of the input audio during the scene.

As noted above, the input audio compression module 210 may determine the difference between the loudness of the normalized AD section that corresponds to the scene and the loudness associated with the input audio during the scene with reference to European Broadcasting Union (EBU) R 128. Specifically, the input audio compression module 210 may measure or obtain the loudness of the normalized AD section that corresponds to the scene and the loudness associated with the input audio during the scene pursuant to EBU R 128, and calculate the difference between the loudness of the normalized AD section that corresponds to the scene and the loudness associated with the input audio during the scene. Based on the difference, the input audio compression module 210 may classify the difference to a range of a plurality of ranges. For example, the difference between the loudness of the normalized AD section that corresponds to the scene and the loudness associated with the input audio during the scene may be classified by the input audio compression module 210 to one of nine, ten, eleven, or any other number of ranges. Based on the classification, the input audio compression module 210 may generate parameters suitable for compressing one or more audio channels of the input audio during the scene. For a scene where a loudness of a normalized AD section is much lower than a loudness associated with the input audio during the scene, the input audio compression module 210 may generate a set of parameters for compressing one or more audio channels of the input audio during the scene. For a scene where a loudness of a normalized AD section is approaching a loudness associated with the input audio during the scene, the input audio compression module 210 may generate a different set of parameters for compressing one or more audio channels of the input audio during the scene minimally.

Thereafter, at (9), the audio mixer 212 may mix the normalized narration file generated at (7) to at least one compressed audio channel(s) to generate an AD content. For example, the audio mixer 212 may mix the normalized narration file to a compressed audio channel (e.g., compressed FC channel) to generate a FC channel of the AD content. The audio mixer 212 may generate other channels of the AD content using other compressed audio channels (e.g., compressed FL channel, compressed FR channel, compressed LFE channel, compressed BL channel, and compressed BR channel) generated by the input audio compression module 210 without mixing the normalized narration file to the other compressed audio channels.

At (10), the audio mixer 212 may store and/or transmit the AD content to end users. For example, the audio mixer 212 may store the AD content in a data store (not shown in FIG. 4) associated with the AD content system 106 and/or transmits the AD content to end user devices 102.

### Example Implementations of Related Modules

FIG. 5 illustrates an example block diagram of the AD normalizer 208 of FIGS. 2, 3, and 4 in accordance with some embodiments of the present disclosure. As shown in FIG. 5, the AD normalizer 208 may receive m audio channels (e.g., channel 560-1 through channel 560-m) of an input audio from the dynamic range adjustment module 204, and n AD sections 502-1 through 502-n of an AD narration from the AD narration generator 206. Each of the n AD sections may correspond to a scene (e.g., one of N scenes 552-1 through 552-N) of the input audio. Each of the n AD sections may be normalized based on a loudness associated with the m audio channels during the scene. The loudness associated with the m audio channels may be a loudness of an audio that is mixed with the m audio channels.

For example, a loudness of the AD section 502-1 that corresponds to a scene 552-1 starting at time T1 and ending at time T1′ may be normalized based on the loudness associated with the m audio channels during the scene 552-1. More specifically, the get loudness 504-1 may measure a loudness of the AD section 502-1. For example, the get loudness 504-1 may measure the loudness of the AD section 502-1 pursuant to EBU R 128. Additionally and/or optionally, the add padding 506-1 may pad blank audio to the AD section 502-1 if the AD section 502-1 is shorter than a predetermined time period (e.g., 10 seconds, 15 seconds, or the like). Advantageously, padding blank audio to an AD section that is shorter than the predetermined time period may improve performance of normalization because some normalization techniques may exhibit inferior performance when operating on AD sections that shorter than the predetermined time period.

Based on the loudness 556-1 associated with the m audio channels during the scene 552-1 that is obtained by the get loudness 554-1, the normalizer 508-1 may normalize the loudness of the AD section 502-1. The normalizer 508-1 may raise or lower the loudness of the AD section 502-1 based on the loudness 556-1. Additionally and/or optionally, the normalizer 508-1 may keep the loudness of the AD section 502-1 to a predetermined range (e.g., the quietest sound in a normalized AD section 558-1 is above a first decibel value and the loudest sound in the normalized AD section 558-1 is below a second decibel value that is higher than the first decibel value). The remove padding 510-1 may remove blank audio, if any, padded to the AD section 502-1 by the add padding 506-1 from the normalized AD section 558-1. The delay 512-1 may delay the normalized AD section 558-1 according to a start time (e.g., T1) or an end time (e.g., T1′) of the normalized AD section 558-1 for generating the normalized narration file 580 or another intermediate file.

Although not explicitly illustrated in FIG. 5, the AD normalizer 208 may normalize other AD sections (e.g., the remaining AD sections through AD section 502-n) of the AD narration similar to normalizing the AD section 502-1. For example, the normalizer 508-n may normalize the AD section 502-n based on a loudness 556-N associated with the m audio channels during the scene 552-N to generate the normalized AD section 558-n. The delay 512-n may insert the normalized AD section 558-n to the normalized narration file 580 according to a start time (e.g., Tn) or an end time (e.g., Tn′) of the normalized AD section 558-n. As such, the normalized narration file 580 may include n normalized AD sections 558-1 through 558-n. In various implementations, other portions of the normalized narration file 580 that are not occupied by any of the n normalized AD sections 558-1 through 558-n may be silent audio. Further, the normalized narration file 580 may have a duration (e.g., ninety minutes, or other durations) that is the same as a duration of the input audio. The normalized narration file 580 may be utilized by the audio mixer 212 for mixing with at least one compressed audio channel generated from an input audio by the input audio compression module 210, as described at (9) of FIG. 4.

FIG. 6 illustrates an example block diagram of the input audio compression module 210 of FIGS. 2, 3, and 4 in accordance with some embodiments of the present disclosure. As shown in FIG. 6, the input audio compression module 210 includes the loudness comparator 606, the loudness difference classifier 608, and the processor core 610-1 that includes the side chain compressor 612-1 and the concatenator 614-1. Although not explicitly shown in FIG. 6, the input audio compression module 210 may include additional processor cores, depending on desired level of parallelism the AD content system 106 intends to achieve.

In some embodiments, the loudness comparator 606 may determine a difference between a loudness of the normalized AD section 558-1 and a loudness associated with an input audio during the scene 552-1. For example, the loudness comparator 606 may determine that the difference between the loudness of the normalized AD section 558-1 and the loudness of an input audio during the scene 552-1 is 0 dB, −1 dB, −5 dB, −10 dB, −20 dB, −30 dB, −40 dB, −50 dB, or any other values therebetween. Based on the difference between the loudness of the normalized AD section 558-1 and the loudness of an input audio during the scene 552-1, the loudness difference classifier 608 may classify the difference to one of a number of ranges, where the number can be any integer greater than one. For example, the loudness difference classifier 608 may classify the difference between the loudness of the normalized AD section 558-1 and the loudness of an input audio during the scene 552-1 to one of nine ranges, where a first range may correspond to the difference being between 0 dB to −5 dB (e.g., the loudness of the normalized AD section 558-1 can be from the same as the loudness of the input audio during the scene 552-1 to 5 dB less than the loudness of the input audio during the scene 552-1), a second range may correspond to the difference being between −5 dB to −10 dB, and so forth.

Based on which range the difference between the loudness of the normalized AD section 558-1 and the loudness of an input audio during the scene 552-1 is classified to by the loudness difference classifier 608, the loudness difference classifier 608 may generate a set of parameters for compressing the input audio during the scene 552-1. Specifically, if a loudness of the normalized AD section 558-1 is much lower than a loudness associated with the input audio during the scene 552-1, the loudness difference classifier 608 may generate a set of parameters for compressing one or more audio channels (e.g., channel 560-1 through channel 560-m) of the input audio during the scene 552-1 to a greater degree. However, if a loudness of the normalized AD section 558-1 is approaching a loudness associated with the input audio during the scene 552-1, the loudness difference classifier 608 may generate a different set of parameters for compressing one or more audio channels of the input audio during the scene 552-1 minimally. [0065] Using the parameters provided by the loudness difference classifier 608, the side chain compressor 612-1 may compress channel 560-1 during the scene 552-1 based on the loudness of the normalized AD section 558-1 to generate a compressed audio channel 616-1 during the scene 552-1. As illustrated in FIG. 6, the scene 552-0 and the scene 552-2 where there are no corresponding normalized AD section(s) may not be compressed by the side chain compressor 612-1. The compressed audio channel 616-1 during the scene 552-1 may be concatenated by the concatenator 614-1 with the channel 560-1 during the scene 552-0 and the channel 560-1 during the scene 552-2 to generate the side chain compressed channel 618-1 during scenes 552-0, 552-1 and 552-2.

Instead of or in addition to compressing audio channel(s) of the input audio to a greater or a less extent, a set of parameters generated by the loudness difference classifier 608 may be utilized to achieve smooth transitions between scenes that correspond to normalized AD sections (e.g., “AD scenes”) and scenes that do not correspond to normalized AD sections (e.g., “non-AD scenes”). In some examples, transition durations between AD scenes and non-AD scenes may be proportional to the loudness differences between normalized AD sections and corresponding scenes of the input audio. For example, when a difference between the loudness of the normalized AD section 558-1 and the loudness of the input audio during the scene 552-1 exceeds a threshold or is otherwise relatively large (e.g., the loudness of the input audio during the scene 552-1 is over 50 dB than the loudness of the normalized AD section 558-1), the input audio compression module 210 may compress the scene 552-1 using the set of parameters such that the loudness of the scene 552-1 gradually transitions from louder sound to quieter sound over a period of time (e.g., seconds or milliseconds) rather than abruptly changes from the louder sound to the quieter sound. When the difference between the loudness of the normalized AD section 558-1 and the loudness of the input audio during the scene 552-1 is below a threshold or is otherwise relatively small (e.g., the loudness of the input audio during the scene 552-1 is no more than 10 dB than the loudness of the normalized AD section 558-1), the input audio compression module 210 may compress the scene 552-1 using the set of parameters such that the loudness of the scene 552-1 may more quickly transition from louder sound to quieter sound (e.g., the transition may occur over a shorter period of time than when the difference is larger). Similarly, the loudness of the scene 552-1 may transition from quieter sound to louder sound toward the end of the normalized AD section 558-1 with varying time durations depending on the difference between the loudness of the normalized AD section 558-1 and the loudness of the input audio during the scene 552-1. Advantageously, adjusting transition durations between AD scenes and non-AD scenes based on loudness differences between normalized AD sections and corresponding scenes in the input audio accomplishes superior listening experiences by avoiding abrupt change in loudness of the input audio.

The example parameters described above are provided for purposes of illustration only, and are not intended to be limiting, required, or exhaustive. In some embodiments, additional and/or alternative parameters may be used.

Although not shown in FIG. 6, other processor cores may simultaneously compress other scenes of the input audio that correspond to one of the remaining normalized AD sections through normalized AD section 558-n. For example, other processor cores (not shown in FIG. 6) may compress the channel 560-1 during other scenes of the input audio that correspond to one of the remaining normalized AD sections through normalized AD section 558-n. As such, the input audio compression module 210 may obtain the channel 660-1, where n of N scenes of the channel 660-1 that correspond to the n normalized AD sections 558-1 through 558-n may be side chain compressed, Advantageously, employing multiple processor cores to concurrently compress input audio during various scenes may allow the AD content system 106 to generate an AD content in less amount of time.

Additionally and/or optionally, the processor core 610-1 may similarly compress other audio channels (e.g., channel 660-m) during the scene 552-1 to generate side chain compressed channel 618-m during scenes 552-0, 552-1 and 552-2 while other processor cores (not shown in FIG. 6) may simultaneously compress the channel 560-m during other scenes of the input audio that correspond to one of the remaining normalized AD sections through normalized AD section 558-n to obtain the channel 660-m, where n of N scenes of the channel 660-m that correspond to the n normalized AD sections 558-1 through 558-n may be side chain compressed.

### Example Automatic AD Content Generation Routine

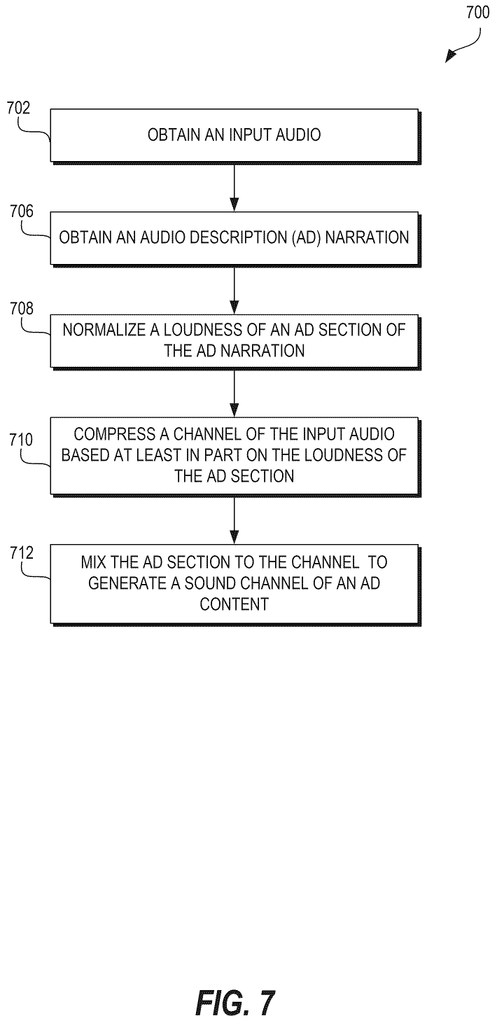

FIG. 7 depicts a flowchart illustrating an example method 700 for automatically generating audio description (AD) content for multimedia content. The method 700 may be implemented, for example, by the AD content system 106 of FIGS. 1 and 2. The method 700 may allow the AD content system 106 to mix an AD narration with an input audio in a multimedia work to generate an AD content. The blocks of FIG. 7 illustrate example implementations, and in various other implementations various blocks may be rearranged, optional, and/or omitted, and/or additional block may be added. In various embodiments, the example operations of the system illustrated in FIG. 7 may be implemented, for example, by the one or more aspects of the AD content system 106, various other aspects of the example computing environment 100, and/or the like.

The method 700 begins at block 702, where the AD content system 106 obtains an input audio. The input audio may be an original audio track to which an AD narration is to be mixed in. The input audio can include one or more audio tracks of a multimedia work (e.g., movies, TV shows, or other multimedia content) that has no AD narration. For example, the input audio preprocessor 202 may obtain an input audio that includes one or more audio channels. The input audio preprocessor 202 may optionally determine one or more audio properties of the input audio, such as an audio channel layout of the input audio. For example, the input audio preprocessor 202 may determine that the input audio has a 5.1 audio channel layout (e.g., an audio stream with six channels: Front-Left (FL), Front-Right (FR), Front-Center (FC), Low-Frequency-Effects (LFE), Back-Left (BL), and Back-Right (BR)).

At block 706, the AD content system 106 may obtain an AD narration. The AD narration may include a plurality of AD sections, where each of the plurality of AD sections may correspond to a scene of the input audio obtained at block 702. In some embodiments, the AD content system 106 may generate the AD narration based on an AD script. For example, based on an AD script that is stored in the AD data store 112, the AD narration generator 206 may generate an AD narration that includes multiple AD sections, where the AD script may be generated by operator 116 and/or machine learning model(s) 114 through watching and/or processing a multimedia work that includes the input audio obtained at block 702. As noted above, the AD script may include narration texts that are tagged with Speech Synthesis Markup Language (SSML) tags. The AD script may indicate a start time, an end time, and narration text for each AD section of the AD narration that is to be generated. Based on information included in the AD script, the AD narration generator 206 may generate the AD narration using various voice synthesizers. For example, the AD narration generator 206 may generate the AD narration using a neural text to speech (NTTS) synthesizer. In various implementations, the NTTS synthesizer may be configured in a multi-threaded fashion such that AD sections of the AD narration may be generated in parallel to conserve processing time.

At block 708, the AD content system 106 may normalize a loudness of an AD section of the AD narration obtained at block 706. In some embodiments, the AD normalizer 208 may normalize a loudness of the AD section of the AD narration based on a loudness of the audio channel(s) of the input audio obtained at block 702. The loudness of the audio channel(s) of the input audio may be a loudness of an audio that is mixed with each audio channel(s) of the input audio. In some embodiments, the AD normalizer 208 may normalize a loudness of the AD section using a loudness of an audio that is mixed with each audio channel(s) of the input audio during a scene of the input audio that the AD section corresponds to for generating a normalized AD section. More specifically, through normalization on the AD section, the AD normalizer 208 may raise or lower the loudness of the AD section based on the loudness of an audio that is mixed with each audio channel(s) of the input audio during a scene the AD section corresponds to. Additionally and/or optionally, the AD normalizer 208 may keep a loudness of the normalized AD section to a predetermined range (e.g., the quietest sound in the normalized AD section is above a first decibel value and the loudest sound in the normalized AD section is below a second decibel value that is higher than the first decibel value).

At block 710, the AD content system 106 may compress a channel (e.g., an audio channel) of the input audio based at least in part on the loudness of the AD section that is normalized at block 708. For example, based on a loudness of the (normalized) AD section that corresponds to a scene of the input audio, the input audio compression module 210 may compress (e.g., using side chain compression) an audio channel (e.g., FC) of the input audio during the scene to generate a portion of a compressed FC channel. In various implementations, the input audio compression module 210 may compress an audio channel of the input audio during a scene based on a difference between a loudness of the (normalized) AD section that corresponds to the scene and a loudness associated with the input audio during the scene, where the loudness associated with the input audio during the scene may take into account a loudness of each audio channel (e.g., a loudness of an audio that is mixed with each audio channel) of the input audio during the scene.

For example, the input audio compression module 210 may determine the difference between the loudness of the (normalized) AD section that corresponds to the scene and the loudness associated with the input audio during the scene with reference to European Broadcasting Union (EBU) R 128. Specifically, the input audio compression module 210 may measure or obtain the loudness of the (normalized) AD section that corresponds to the scene and the loudness associated with the input audio during the scene pursuant to EBU R 128, and calculate the difference between the loudness of the (normalized) AD section that corresponds to the scene and the loudness associated with the input audio during the scene. Based on the difference, the input audio compression module 210 may classify the difference to a range of a plurality of ranges. For example, the difference between the loudness of the (normalized) AD section that corresponds to the scene and the loudness associated with the input audio during the scene may be classified by the input audio compression module 210 to one of nine, ten, eleven, or any other number of ranges. Based on the classification, the input audio compression module 210 may generate parameters suitable for compressing one or more audio channels of the input audio during the scene. For a scene where a loudness of a (normalized) AD section is much lower than a loudness associated with the input audio during the scene, the input audio compression module 210 may generate a set of parameters for compressing one or more audio channels of the input audio during the scene. For a scene where a loudness of a (normalized) AD section is approaching a loudness associated with the input audio during the scene, the input audio compression module 210 may generate a different set of parameters for compressing one or more audio channels of the input audio during the scene minimally.

At block 712, the AD content system 106 may mix the AD section that is normalized at block 708 to the channel (e.g., an audio channel, such as FC) that is compressed at block 710 for generating a sound channel of an AD content. In some embodiments, the audio mixer 212 may mix the AD section to a compressed audio channel (e.g., compressed FC channel) to generate a part of the FC channel of the AD content. The audio mixer 212 may generate other sound channels of the AD content using other compressed audio channels (e.g., compressed FL channel, compressed FR channel, compressed LFE channel, compressed BL channel, and compressed BR channel) generated by the input audio compression module 210 without mixing the AD section to the other compressed audio channels.

In some embodiments, after mixing the AD section to generate a sound channel of an AD content, the audio mixer 212 may optionally boost the sound channel of the AD content without boosting other sound channels of the AD content. Advantageously, boosting the sound channel mixed with AD narration may help achieve non-disruptive user experiences.

### Execution Environment

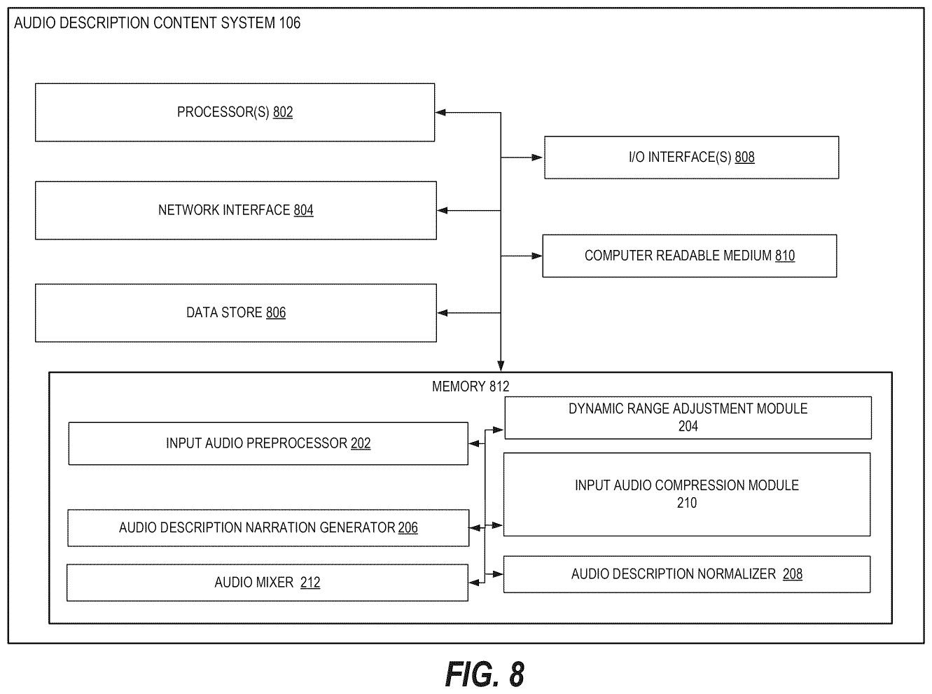

FIG. 8 illustrates various components of an example AD content system 106 configured to implement various functionality described herein. FIG. 8 depicts an example architecture of a computing device (e.g., the AD content system 106) that can be used to perform one or more of the techniques described herein or illustrated in FIGS. 1-7. The general architecture of the AD content system 106 depicted in FIG. 8 includes an arrangement of computer hardware and software modules that may be used to implement one or more aspects of the present disclosure. The AD content system 106 may include many more (or fewer) elements than those shown in FIG. 8. It is not necessary, however, that all of these elements be shown in order to provide an enabling disclosure.

In some embodiments, the AD content system 106 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provided by the AD content system 106 may be implemented as web services consumable via one or more communication networks. In further embodiments, the AD content system 106 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

In some embodiments, as shown, the AD content system 106 may include: one or more processors 802, such as physical central processing units (“CPUs”); one or more network interfaces 804, such as a network interface cards (“NICs”); one or more computer readable medium 810, such as a high density disk (“HDDs”), solid state drives (“SSDs”), flash drives, and/or other persistent non-transitory computer readable media; one or more input/output (I/O) interfaces; and one or more memory 812, such as random access memory (“RAM”) and/or other volatile non-transitory computer readable media.

The processor 802 may also communicate with memory 812. The memory 812 may contain computer program instructions (grouped as modules or units in some embodiments) that the processor 802 executes in order to implement one or more aspects of the present disclosure. The memory 812 may include random access memory (RAM), read only memory (ROM), and/or other persistent, auxiliary, or non-transitory computer-readable media. Additionally, the memory 812 can be implemented using any suitable memory technology (e.g., one or more of cache, static random access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). The memory 812 may store an operating system (not shown in FIG. 6) that provides computer program instructions for use by the processor 802 in the general administration and operation of the AD content system 106.

The memory 812 may include computer program instructions that one or more processors 802 execute in order to implement one or more embodiments. In some embodiments, the memory 812 may further include computer program instructions and other information for implementing one or more aspects of the present disclosure, including but not limited to the input audio preprocessor 202, the AD narration generator 206, the dynamic range adjustment module 204, the input audio compression module 210, the AD normalizer 208, and the audio mixer 212. The processor 802 may execute the instructions or program code stored in the memory 812 to perform audio processing algorithms disclosed herein, such as generating an AD content based on an AD script and an input audio by utilizing utilize scene-by-scene compression to compress the input audio based on an AD narration generated from the AD script, where the AD narration is to be mixed with the input audio for generating the AD content. In some embodiments, parts or all of the input audio preprocessor 202, dynamic range adjustment module 204, AD narration generator 206, AD normalizer 208, input audio compression module 210, and audio mixer 212 may be implemented by hardware circuitry, firmware, software or a combination thereof.

### Terminology and Additional Considerations

Some or all of the statistical analysis methods described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A computer-implemented method comprising:
under control of a computing system comprising one or more computer processors configured to execute specific instructions,
obtaining an input audio comprising one or more audio channels, the input audio being an audio track of a video content item;
obtaining an audio description (AD) narration, wherein the AD narration comprises a plurality of AD sections of narration of the video content item between sections of dialogue of the input audio, a first AD section and a second AD section of the plurality of AD sections respectively corresponding to a first scene and a second scene of the input audio;
normalizing, using a first loudness level associated with the one or more audio channels during the first scene, a second loudness level of the first AD section to generate a first normalized AD section with a first normalized loudness level;
normalizing, using a third loudness level associated with the one or more audio channels during the second scene, a fourth loudness level of the second AD section to generate a second normalized AD section with a second normalized loudness level;
compressing, by a first computer processor of the one or more computer processors, a first audio channel of the one or more audio channels during the first scene based at least in part on the first normalized loudness level of the first normalized AD section to generate a first portion of a first compressed audio channel;
compressing, by a second computer processor of the one or more computer processors, the first audio channel of the one or more audio channels during the second scene based at least in part on the second normalized loudness level of the second normalized AD section to generate a second portion of the first compressed audio channel; and
mixing the first normalized AD section to the first compressed audio channel during the first scene and the second normalized AD section to the first compressed audio channel during the second scene to generate a first sound channel of an AD content,
wherein the AD content comprises the video content item and provides narration of the video content item between the sections of dialogue.

2. The computer-implemented method of claim 1, further comprising:
adjusting a dynamic range of the first audio channel prior to normalizing the second loudness level of the first AD section and the fourth loudness level of the second AD section.

3. The computer-implemented method of claim 1, wherein compressing the first audio channel during the first scene is based on a difference between the first normalized loudness level of the first normalized AD section and the first loudness level associated with the one or more audio channels during the first scene, and wherein compressing the first audio channel during the second scene is based on a difference between the second normalized loudness level of the second normalized AD section and the third loudness level associated with the one or more audio channels during the second scene.

4. The computer-implemented method of claim 3, further comprising:
determining the difference between the first normalized loudness level of the first normalized AD section and the first loudness level associated with the one or more audio channels during the first scene;
determining the difference between the second normalized loudness level of the second normalized AD section and the third loudness level associated with the one or more audio channels during the second scene;
classifying the difference between the first normalized loudness level of the first normalized AD section and the first loudness level associated with the one or more audio channels during the first scene to a first range of a plurality of ranges;
classifying the difference between the second normalized loudness level of the second normalized AD section and the third loudness level associated with the one or more audio channels during the second scene to a second range of the plurality of ranges;
generating, based on the first range, a first parameter set for compressing the first audio channel during the first scene; and
generating, based on the second range, a second parameter set for compressing the first audio channel during the second scene.

5. A system for generating an audio description (AD) content, the system comprising:
memory that stores computer-executable instructions; and
one or more processors in communication with the memory, wherein the computer-executable instructions, when executed by the one or more processors, cause the one or more processors to:
obtain an input audio comprising audio for a video content item;
obtain an AD narration, wherein the AD narration comprises a plurality of AD sections, a first AD section of the plurality of AD sections corresponding to a first scene of the input audio;
modify, using a loudness level associated with the first scene, a loudness level of the first AD section to generate a first modified AD section;
modify, based at least in part on a loudness level of the first modified AD section, the first scene of the input audio to generate a first modified scene; and
mix the first modified AD section and the first modified scene to generate a first AD content scene.

6. The system of claim 5, wherein a second AD section of the plurality of AD sections corresponds to a second scene of the input audio, and wherein the computer-executable instructions, when executed, further cause the one or more processors to:
modify, using a loudness level associated with the second scene, a loudness level of the second AD section to generate a second modified AD section;
modify, based at least in part on a loudness level of the second modified AD section, the second scene of the input audio to generate a second modified scene; and
mix the second modified AD section and the second modified scene to generate a second AD content scene.

7. The system of claim 6, wherein the input audio comprises a third scene between the first scene and the second scene, and wherein the third scene of the input audio is unmodified.

8. The system of claim 7, wherein the computer-executable instructions, when executed, further cause the one or more processors to:
concatenate the first scene of the input audio and the third scene of the input audio.

9. The system of claim 5, wherein the input audio comprises one or more audio channels of the audio for the video content item.

10. The system of claim 9, wherein the computer-executable instructions, when executed, further cause the one or more processors to:
boost the first AD content scene.

11. The system of claim 5, wherein the computer-executable instructions, when executed, further cause the one or more processors to:
insert the first modified AD section, according to a start time or an end time of the first scene, to a silent audio file to generate a normalized narration file.

12. The system of claim 11, wherein a duration of the normalized narration file equals a duration of the input audio.

13. The system of claim 5, wherein the computer-executable instructions, when executed, further cause the one or more processors to:
generate, based on an AD script, the AD narration.

14. The system of claim 13, wherein the AD script is generated by a machine learning (ML) model or a human operator.

15. The system of claim 13, wherein the AD narration is generated using a computer synthesized speech voice.

16. The system of claim 5, wherein the computer-executable instructions, when executed, further cause the one or more processors to:
determine one or more audio properties of the input audio; and
split, based at least in part on the one or more audio properties of the input audio, the input audio into one or more audio channels.

17. The system of claim 5, wherein modifying the loudness level of the first AD section comprises increasing or decreasing the loudness level of the first AD section based on the loudness level associated with the first scene.

18. The system of claim 5, wherein the computer-executable instructions, when executed, further cause the one or more processors to:
adjust a dynamic range of the first scene prior to modifying the first scene,
wherein adjusting the dynamic range of the first scene comprises limiting the loudness level associated with the first scene to a predetermined loudness level.

19. A computer-implemented method comprising:
under control of a computing system comprising one or more computer processors configured to execute specific instructions,
obtaining an input audio comprising audio for a video content item;
obtaining an AD narration, wherein the AD narration comprises a plurality of AD sections, a first AD section of the plurality of AD sections corresponding to a first scene of the input audio;
modifying, using a loudness level associated with the first scene, a loudness level of the first AD section to generate a first modified AD section;
modifying, based at least in part on a loudness level of the first modified AD section, the first scene of the input audio to generate a first modified scene; and
mixing the first modified AD section and the first modified scene to generate a first AD content scene.

20. The computer-implemented method of claim 19, wherein modifying the first scene of the input audio is based on a difference between the loudness level of the first modified AD section and the loudness level associated with the first scene.
